(19) United States
(12) Patent Application Publication
(10) Pub. No.: US 2013/0239477 A1
(43) Pub. Date: Sep. 19, 2013

(54) METHOD OF INCREASING PLANT BRANCHING

(71) Applicant: SUNTORY FLOWERS LIMITED, TOKYO (JP)

(72) Inventor: JACOB C. SMOLENAARS, GOUDA (NL)

(73) Assignee: SUNTORY FLOWERS LIMITED, TOKYO (JP)

(21) Appl. No.: 13/800,990

(22) Filed: Mar. 13, 2013

Related U.S. Application Data
(60) Provisional application No. 61/610,616, filed on Mar. 14, 2012.

(51) Int. Cl. A01G 9/02

(52) U.S. Cl. CPC A01G 9/02
USPC 47/66.7; 47/58.1 R; 47/65.5

(57) ABSTRACT

A method of increasing plant branching is disclosed. The invention relates to producing a compact and uniform horticultural display. The invention further relates to producing a horticultural display with plants of different families, genera and species that are difficult to grow into compact, uniform and floriferous horticultural displays.

### CROSS-REFERENCE TO RELATED APPLICATIONS

This application is a non-provisional application of and claims priority to U.S. Provisional Patent Application No. 61/610,616, filed on Mar. 14, 2012, which is herein incorporated by reference in its entirety.

### BACKGROUND OF THE INVENTION

The present invention relates to horticultural products, more particularly to a method of increasing plant branching in a horticultural display with the same or different plant species, and producing a horticultural display with compact and uniform plant growth. All publications cited in this application are herein incorporated by reference.

Many ornamental plants are commonly produced for display inside or outside the home in the plant's growing container. These plants are often referred to as a ‘container plant,’ ‘container display,’ or a ‘horticultural display’ as opposed to plants intended to be transplanted into soil or other plant growing media in a landscape or interiorscape. Retail consumers tend to select container plants that are bushy, compact, and have uniform growth habits. Thus, the producer must keep in mind the consumer's expectation when selecting plants for this purpose. Plants selected for display in a container are often naturally highly branching plants that maintain compact and uniform growth and require little or no pruning Selection can also be based on the plant having attractive flowers.

Many attractive flowering plants are not well suited as container plants because of their thin or sparse growth habit. A number of flowering plants are difficult to be successfully grown as container plants. Often they produce woody and rigid branches with few side branches and many dominant leader branches. This is true for many vines and climbers. These plants do not particularly hold a compact and uniform shape in a container display and have not traditionally been used in container displays. However, they do produce attractive flowers that would be enhanced if they could be grown in a container such as a hanging basket.

In addition to satisfying the consumer with attractive horticultural displays, plant producers select plants for container displays that require less growing space for production. Plants that require large amounts of growing space increase production cost for the producer and ultimately increase retail cost for the consumer. Growth retardants are widely used in the ornamental plant industry to keep plants compact and uniform, not only to enhance their attractiveness, but also to reduce the amount of growing area required per plant. However, many plants that have attractive flowers but lack compactness and uniformity do not respond well to growth retardants. Due to the difficulty of growing these plants as container plants, the variety of container plants available to the retail consumer has been restricted. To date, there has not been a growing method for many plant species that details how they can be grown compactly and uniformly to produce attractive container displays. Lieth and Soo reported that shoot bending improved the canopy density in rose (Lieth, H. and Soo, K., Development of optimal rose canopy management strategies for rose growers: “Bending” versus traditional production, Environmental Horticulture, University of California, Final Report to Roses, Inc. and the Joseph Hill Memorial Foundation, Jan. 1, 1999-Jun. 30, 1999); however, the study concluded that shoot bending significantly reduces flower production.

Thus, there is a need for a method to effectively grow container plants utilizing plant genera and species that do not currently grow well in containers. In addition, the need arises for a method that can utilize more plant genera and species in horticultural displays that are attractive to the consumer.

### SUMMARY OF THE INVENTION

The present invention provides a method of increasing a plant's compactness, uniformity and floriferousness when grown in a containerized horticultural display. The major elements of the method may be summarized as comprising: 1) growing shoots, primary branches, secondary branches, or additional branches; 2) pinching the terminal ends to remove the apical meristem of growing shoots, primary branches, secondary branching, or additional branches; 3) fastening the growing shoots, primary branches, secondary branches, or additional branches to a support.

It is in accordance with one embodiment of the present invention to provide a method to grow certain types of plants that are not well adapted to be grown as a container plant.

It is in accordance with another embodiment of the present invention to reduce or completely eliminate the use of growth retardants.

It is in accordance with one embodiment of the present invention to plant one or more of a plant plug, rooted cutting, or unrooted cutting into the growing medium of a growing container to produce a shoot.

In accordance with another embodiment of the present invention, the growing shoot is bent and the terminal end of the shoot is fastened to a support to maintain the shoot in a bent state.

In accordance with another embodiment of the present invention, the shoot is fastened to the edge of the growing container.

In accordance with another embodiment of the present invention, the shoot is fastened to the surface of the growing medium.

In accordance with a further embodiment of the present invention, the shoot is fastened to the outside surface of the growing container.

In accordance with a further embodiment of the present invention, the shoot is fastened to a hanging means attached to the growing container.

In accordance with another embodiment of the present invention, the shoot is fastened to an object placed on top of the growing medium.

It is in accordance with another embodiment of the present invention to produce primary branches from the shoot by removing the apical meristem of the shoot, for example by pinching, removing, cutting or killing the apical meristem of the shoot.

In accordance with another embodiment of the present invention, the growing primary branches are bent and the terminal ends are fastened to a support to maintain the primary branches in a bent state.

In accordance with another embodiment of the present invention the primary branches are fastened to the edge of the growing container.

In accordance with another embodiment of the present invention, the primary branches are fastened to the surface of the growing medium.

In accordance with another embodiment of the present invention the primary branches are fastened to the outside surface of the growing container.

In accordance with another embodiment of the present invention the primary branches are fastened to a hanging means attached to the growing container.

In accordance with a further embodiment of the present invention the primary branches are fastened to an object placed on top of the growing medium.

It is in accordance with one embodiment of the present invention to produce secondary branches from the primary branches by removing the apical meristem of the primary branches, for example by pinching, removing, cutting or killing the apical meristem of the primary branch.

It is in accordance with a further embodiment of the present invention to produce a containerized horticultural display having compact, uniform, and floriferous plants.

These and other aspects, as well as the scope, nature, and utilization of the claimed invention will be apparent to those skilled in the art from the following detailed description and appended claims.

### BRIEF DESCRIPTION OF THE DRAWINGS

Numerous other objects and advantages of the present invention will become apparent from the consideration of the following disclosure taken in conjunction with the drawings, in which:

FIG. 1 shows unrooted plant cuttings before being placed into a rooting medium.

FIG. 2 shows rooted cuttings in a growth cell or liner containing a growing medium.

FIG. 3 shows plants of the rooted cuttings in a growing container.

FIG. 4 shows bent and fastened shoots of the rooted cuttings.

FIG. 5 shows primary branches growing from shoots in a growing container.

FIG. 6 shows bent and fastened primary branches growing from bent and fastened shoots of rooted cuttings.

FIG. 7 shows a fuller horticultural display of the bent and fastened shoots and branches.

FIG. 8 shows rooted cuttings of mandevilla plants growing in a growing container.

FIG. 9 shows mandevilla shoots before being bent and fastened to the edge of the growing container.

FIG. 10 shows mandevilla shoots fastened to the edge of the growing container.

FIG. 11 shows a close up of an example of a fastener used to fasten mandevilla shoots and branches to the edge of the growing container.

FIG. 12 shows a fuller horticultural display of the bent and fastened shoots and branches of mandevilla plants.

### DETAILED DESCRIPTION OF THE INVENTION

The present invention (hereinafter referred to as the Bend, Fasten and Pinch system or BFP system) is directed towards a method of producing a container plant, container display or horticultural display that is more attractive because the plants are more compact, produce more flowers, and have increased branching. Therefore, the plant producer can produce a product that is more attractive and has greater value. Because plants grown by the present technique are more compact, they require less growing space. In addition, the use of growth retardants is reduced or completely eliminated.

In one embodiment of the present invention, plants such as Mandevilla benefit from the BFP system. Mandevilla is a woody stem plant with a highly branching growth habit. Because of these characteristics, maintaining Mandevilla in a compact and uniform hanging basket display is not possible. The BFP system can easily be applied to Mandevilla, and especially to other plants that have a growth habit similar to Mandevilla.

In the description that follows, a number of terms are used. In order to provide a clear and consistent understanding of the specification and claims, including the scope to be given such terms, the following definitions are provided:

Additional branches: Branches that originate from and are held by a secondary branch. Additional branches can be attached directly to a secondary branch or attached indirectly by a plurality of branches connected to the secondary branch.

Apical meristem dominance: Refers to a phenomenon whereby the main central stem or branch of a plant is dominant over its own side branches and the presence of the apical bud or meristem inhibits growth of those side branches.

Apical meristem: Region of undifferentiated plant tissue located at the apex of plant branches and roots, and usually having a dominant growth influence over the lateral meristematic growing points.

Bend, Fasten, and Pinch (BFP): A method of producing a compact and floriferous plant in a container comprising: 1) growing shoots, primary branches, secondary branches, or additional branches; 2) pinching the terminal ends to remove the apical meristem of growing shoots, primary branches, secondary branches, or additional branches; 3) fastening the growing shoots, primary branches, secondary branches, or additional branches to a support.

Bent position: Refers to a branch that is moved and oriented to a different position from its natural growing position.

Branch: Refers to a primary branch, secondary branch, or additional branch.

Climber: A plant that uses other plants, rocks, or manmade structures for support.

Compact and uniform growth: Refers to plants grown with short branches, numerous leaves and numerous flowers. The growth of the plant is in proportion to the size of the growing container.

Container: As used herein a ‘container’ or ‘growing container’ is any object that holds a plant's growing medium. Examples of containers include, but are not limited to, hanging baskets, table pots, ground pots, or bulb pans.

Container display: A plant exhibited for decoration in its growing container.

Container plant: A plant that has it roots held in a growing medium within a container.

Fasten: Refers to a process whereby a shoot, primary branch, secondary branch, or additional branch is attached with a fastening means to a supporting means.

Fastening means: Any means by which to attach a shoot, primary branch, secondary, or additional branch to a support means. Fastening means include, but are not limited to clips, stakes, elastic bands, ties, wire, rope, string, or twine.

Final container: Refers to the container in which a plant is grown and then sold to the consumer.

Floriferousness: Refers to the level of flowering or the quantity of blooms.

Frame: As used herein ‘frame’ refers to an object of a shape, for example a globe, cube, cylinder, or cone, placed near to or on top of the growing medium in a growing container. The frame is used to provide a support means for fastening a plant's shoot, primary branch, secondary branch, or additional branches.

Growing medium: A substrate in which a plant has its roots anchored and usually having organic and inorganic components including, but not limited to soil, peat, sand, humus, bark, and coconut fiber.

Growth regulator: Any substance or mixture of substances intended, through physiological action, for accelerating or retarding the rate of growth or maturation or for otherwise altering the behavior of ornamental or crop plants or the produce thereof, but not including substances intended as plant nutrients, trace elements, nutritional chemicals, plant inoculants, or soil amendments.

Growth retardant: A growth regulator applied to a plant to reduce its normal height and growth rate. Examples of growth retardants include, but are not limited to ancymidol, paclobutrazol, and chlormequat.

Hanging means: A device attached to a growing container and usually having at its distal end an inversion or ‘hook’ that allows the growing container to be suspended to a support.

Horticultural display: As used herein ‘horticultural display’ is a plant grown by using the Bend, Fasten and Pinch (BFP) method of the present invention.

Lateral branch: A branch arising from a lateral meristem. As used herein, a ‘lateral branch’ can be a primary branch, secondary branch, or additional branch.

Lateral meristems: Regions of undifferentiated plant tissue located at the base of leaf petioles which are attached to the sides of a branch. Lateral meristems have the capability of producing a lateral branch.

Mandevilla: Is a genus of mostly tropical and subtropical flowering plants belonging to the family Apopcynaceae and having a scandent or climbing growth habit.

Non-final container: Refers to a container in which a plant is grown to a specified size, and then removed from this container and transferred to another container for continued growth.

Orchid flower spike fastening clip: Generally a circular or U-shaped device that is used to fasten an orchid flower spike to a stake.

Pinching: As used herein ‘pinching’ means removing part or all of the apical meristem of a shoot or branch.

Plant: As used herein the term ‘plant’ means an immature or mature plant including a plug, unrooted cutting, rooted cutting or tissue culture.

Plug: A small rooted plant in a growing medium that is planted into a larger growing container to continue growth and development of the plant.

Primary branch: As used herein, ‘primary branch’ refers to the plant growth that originates from lateral meristems on a shoot.

Removing the apical meristem: Preventing the growth of meristems on a plant's shoot, or lateral branches by any means including, but not limited to removing, pinching, cutting, pruning, or killing the meristems by chemical or any physical means.

Rooted cutting: A plant with roots, a shoot, one or more leaves and an apical meristem.

Rooting hormone: A class of chemicals produced either naturally or synthetically that can initiate roots on a plant.

Rooting media: A formulation usually composed of very fine soil material that is conducive for allowing an unrooted plant cutting to develop roots when the cutting is placed in the rooting media.

Scandent: Refers to a climbing mode of plant growth.

Secondary branch: As used herein, ‘secondary branch’ refers to the plant growth that originates from lateral meristems on a primary branch.

Shoot: As used herein the term ‘shoot’ refers to the above ground portion of a plant that is in the first stage of growth after being transplanted to a growing container.

Support: As used herein a ‘support’ is any object or location on, within or outside the growing container that can provide a means by which to fasten and hold in position a plant's shoot, primary branch, secondary branch or additional branches. Examples of a support include, but are not limited to the edge of the growing container, a hanging means attached to the growing container, the surface of the growing medium, an object placed on the surface of the growing medium, or the inside or outside frame of the growing container.

Unrooted cutting: A plant without roots but with the capability of producing roots. An unrooted cutting includes a stem, one or more leaves, and an apical meristem.

Vine: A plant that has a scandent or climbing growth habit.

### FURTHER EMBODIMENTS OF THE INVENTION

In accordance with one embodiment of the present invention, a method of producing an attractive horticultural display is described. This is achieved by bending a shoot so that it is maintained in a bent position. As reported by Choudhary, shoot bending or ‘mother shoot’ bending has a particular advantage of stimulating ground shoot production and making the ground shoots stronger (S. N. Choudhary, Cultivation of cut flower—Dutch Rose, from Krishisewa Agriculture information Hub, www.krishisewa.com/cms/articles/production-technology/97-dutchrose.html). Another embodiment of this invention is a method to induce plant growth in a direction away from the vertical or normal growing axis which results in a horticultural display that has increased side growth in proportion to upward growth. This is accomplished in one embodiment of this invention, by bending a shoot or branch away from its original growing axis, and fastening the shoot or branch to a support means so that it is maintained in a bent state. Furthermore, another embodiment of the present invention is to induce lateral branching by removing the apical meristem.

Apical meristem dominance can be removed by killing, pinching, pruning or cutting off the end of the plant's shoot, primary branch, secondary branch, or additional branches (see Wilson B. F., Apical control of branch growth and angle in woody plants, American Journal of Botany 87(5): 601-607 (2000)). For example, the end of a shoot contains an apical meristem, which is the location where shoot growth occurs. The apical mersitem produces indole-3-acetic acid (IAA), an auxin that inhibits growth of the lateral meristems further down on the stem. Auxin from apical buds travels down shoots to inhibit lateral mersitem growth. This promotes shoot growth, and restricts lateral branching. When the apical meristem is removed, the lowered IAA concentration allows the lateral mersitems to grow and produce new shoots and branches, which compete to become the lead growth. The method of the present invention in one embodiment redirects plant growth to produce a desired shape, size, and/or productivity level for the plant. Chemical removal of the apical meristem is also possible. A chemical with herbicidal activity selectively targets the apical meristem of the plant's shoot or branch. Some chemical pruning agents are methyl esters of fatty acids which are not translocated, but act by killing meristematic tissue when absorbed.

Either chemically or physically, the removal of the apical meristem results in an increased growth in the lateral meristematic growing regions of the plant. To further achieve lateral branching, in another embodiment of this invention, a treatment with a natural or synthetic growth hormone can be used separately or in combination with physically removing the apical meristem. These hormones are typically referred to as cytokinins. Some examples of cytokinins include but are not limited to 6-Benzylaminopurine (BA), 6-(α,α-dimethylallylamino)-purine (2iP), zeatin, and kinetin. Cytokinins act in concert with auxin. The inhibition of lateral meristem growth results from a plant having a naturally higher ratio of auxin to cytokinin. Reversing this ratio (i.e., increasing cytokinin) is well known in the art to have the effect of stimulating lateral meristematic regions to produce lateral branches (see Marini, R. P., Physiology of Pruning Fruit Trees, Virginia Cooperative Extension, Publ. 422-025). As used herein, the term ‘lateral branch’ refers to both primary, secondary, and additional branches. A foliar treatment of a cytokinin has the effect of decreasing the ratio of auxin to cytokinin and stimulates lateral branch growth.

Bending the plant's shoots and removing the apical meristem to induce lateral branching, results in a horticultural display with balanced growth. Balanced plant growth is symmetrical branching upwards and outwards from the center of the growing container. Unexpectedly, this technique has successfully resulted in growing many plant genera and species that have never been grown successfully into compact and uniform horticultural displays. By using these methods of the present invention, plants that cannot be grown compactly and uniformly by current growing methods can now surprisingly be grown into attractive horticultural displays.

In accordance with one embodiment of the present invention a first step is the planting of one or more plants into the growing medium of a container. Also, in another embodiment, the plant is planted directly into the final or finished container. In yet another embodiment, the plant is planted in a non-final container, which unexpectedly produced a horticultural display that achieved the same amount of compactness, uniformity and floriferousness as one in which the plants are planted directly into the final container.

The plant is planted anywhere in the top portion of the container's growing medium. In one preferred embodiment a plant is planted at or near the container's edge allowing the plant's shoot to achieve a greater number of lateral meristems prior to removing the apical meristem.

In accordance with another embodiment of the present invention, the shoot is grown such that it achieves a length that allows the end of the shoot to make contact with a supporting means inside or outside the growing container.

It is also in accordance with another embodiment that the shoot is bent towards an edge of the growing container. Bending can be done in any direction towards any point that can provide a supporting means. In a preferred embodiment, the bending direction is opposite the location where the plant is planted in the growing medium. It is important not to break off the shoot during the bending phase.

In a further embodiment a fastener secures the shoot in the bent position. A fastener is used to attach the shoot to the growing container or any location that can provide a support for the bent shoot. Any of various fasteners are used including but not limited to clips, stakes, elastic bands, ties, wire, rope, string, or twine. In one embodiment, it is advantageous to secure the shoot to the growing container's upper and outer edge. In other embodiments, the shoot is secured to any position within the growing container (such as to the top of the soil surface by a stake), to any position outside the growing container (such as to the growing container's outer surface), or to any position above the growing container (such as to a hanging device).

In addition to bending the shoot, the apical meristem is removed, for example, by pinching. Removing the apical meristem allows for growth and development of primary branches from lateral meristems on the sides of the shoot. In one embodiment, the primary branches are grown and then bent and fastened to a supporting means. Secondary branches are produced by removing the apical meristem on a primary branch. In another embodiment, the secondary branches are grown and then bent and fastened to supporting means.

The steps of bending, fastening, and removing the apical meristem of shoots, primary branches, secondary branches, or additional branches can be performed as many times as necessary until the desired container display is achieved.

Unexpectedly, the method of the present inventions creates a more attractive horticultural display. This is surprising especially when using plant genera and species that are avoided by plant producers because of the difficulty of growing these plants compactly and uniformly. Although not limiting, these plants include woody stem vines and climbers. In accordance with this embodiment, an unexpectedly greater number of plant genera and species can now be grown and offered for sale as attractive container plants. In addition, the method of the present invention opens up more production space in the greenhouse, thus reducing overall production cost. As shown in Example 6, Tables 1-3, this method unexpectedly produces compact and uniform container plants without the use of growth retardants as compared to plants grown without the method of the present invention—which results in cost savings for both labor and materials for the producer. Moreover, this technique gives the retail consumer more options for decorating the home with attractive container plant displays.

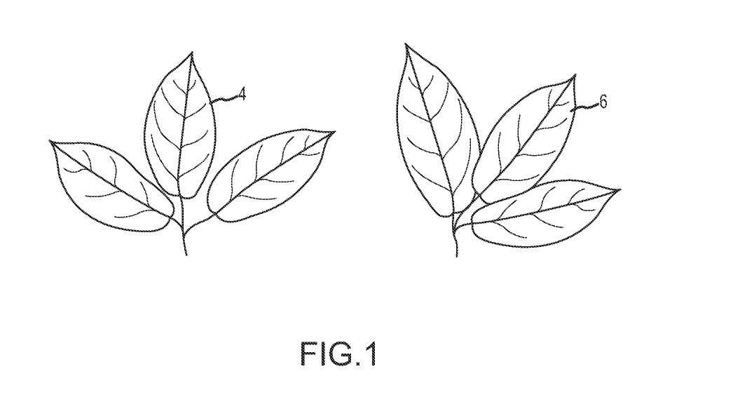

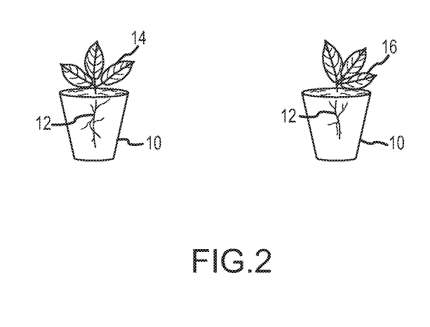

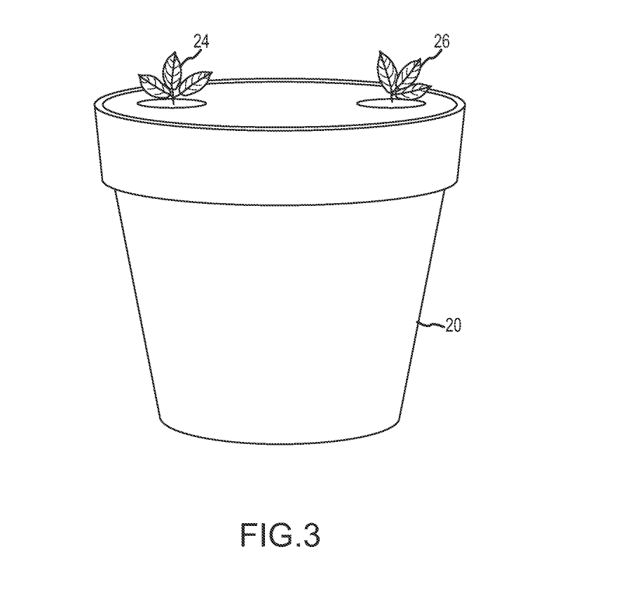

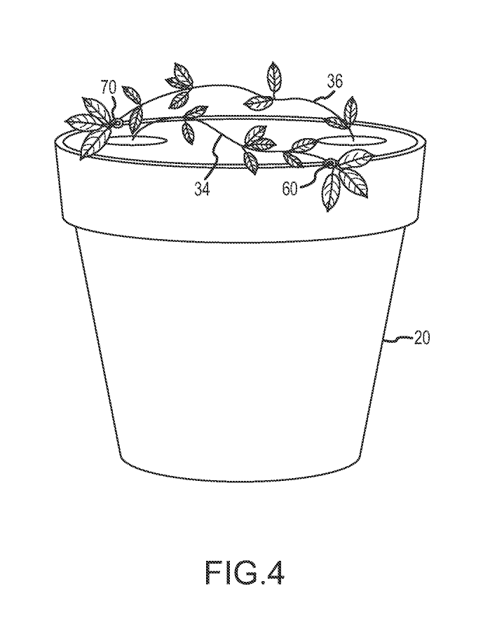

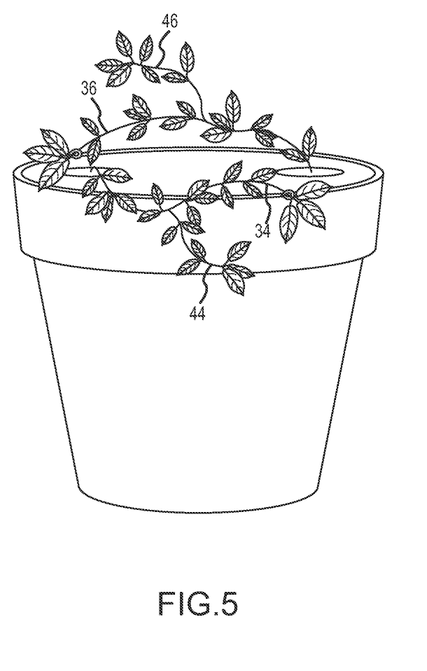

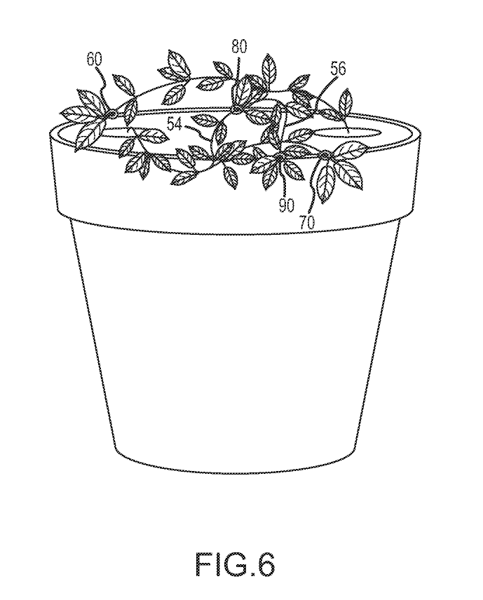

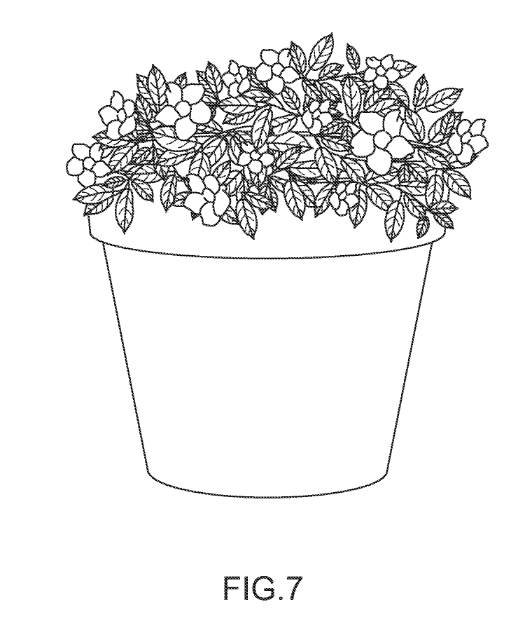

FIGS. 1-7 illustrate one embodiment of a novel method of producing a horticultural display that is provided by the present invention. The method includes bending, fastening and pinching shoots and branches to a supporting means within a growing container, outside a growing container or to the surface of a growing container. FIG. 1 illustrates unroofed plant cuttings, FIG. 2 illustrates rooted cuttings in a growth cell, liner, or other container. FIG. 3 illustrates pre-finished plants of the rooted cuttings in a growing container. FIG. 4 illustrates bent and fastened shoots of the rooted cuttings, FIG. 5 illustrates primary branches growing from shoots in a growing container. FIG. 6 illustrates bent and fastened primary branches growing from bent and fastened shoots of rooted cuttings. FIG. 7 illustrates a horticultural display of the bent and fastened shoots and primary branches. The method as illustrated in FIGS. 1-7 is discussed in greater detail hereinafter.

As shown in FIG. 1, two plant cuttings are used. However, this is for example purposes only, i.e., one cutting can be used or two, three, four, five, six or more cuttings can be used. In one embodiment, two unrooted plant cuttings 4, 6 from the same or different plant species are used. A cutting is a vegetative portion of a plant (such as a leaf, stem or root) that, upon placement in an appropriate environment, will form roots and shoots that will mature into a new plant. In one embodiment the unrooted cuttings 4, 6 are from Mandevilla plants. In other embodiments, the unrootted cuttings 4, 6 are plants selected from the group consisting of, but not limited to, Caprifoliaceae, Apocynaceae, Vitaceae, Convolvulaceae, Ranunculaceae, Araliaceae, Fabaceae, Nyctaginaceae and Oleaceae plant families. The selections may also be made, based at least in part, on compatibility of the growing conditions (i.e., amount of light, amount and frequency of watering, type of soil and nutrients) required for optimal growth and/or flower production. The selections may also be made, based at least in part, on a particular combination of unrooted plant cuttings 4, 6, that will eventually exhibit complementary colors of flowers and/or foliage, contrasting colors of flower and/or foliage, or a combination thereof in the horticultural display.

The selected unrooted plant cuttings 4, 6 are inserted in single growth cells 10 (FIG. 2) and produce one or more of respective rooted cuttings 14, 16 in the single growth cells 10 as shown in FIG. 2. A rooted plant means that the unrooted plant cuttings 4, 6 have at least begun to grow and establish roots in the growth cells 10. The growth cells 10 typically contain rooting media 12, such as potting soil, perlite, vermiculite, sphagnum, peat moss, clay, white pied, and combinations thereof, along with any necessary water and optional nutrients to ensure that roots form on the unrooted plant cuttings 4, 6 to yield the respective rooted cuttings 14, 16 as shown in FIG. 2. The rooted cuttings 14, 16 may exhibit balanced growth, meaning that the rooted cuttings 14, 16 exhibit similar rooting times and growth rate.

In a non-limiting embodiment, manipulating the rooting time of one or more of the unrooted plant cuttings 4, 6, is performed before inserting the unrooted plant cuttings 4, 6 in the single growth cell 10 by applying a growth modifier to one or more of the unrooted plant cuttings 4, 6. Suitable growth modifiers include, but are not limited to the following: plant hormones, such as, abscisic acid, auxins, cytokinins, ethylene, gibberellins, brassinolides, salicylic acid, jasmonates, signaling peptides, systemin, polyamines, nitric oxide, and strigolactones. In a further non-limiting embodiment, a rooting hormone, such as indole-3-butyric acid, is applied to one or more of the unrooted plant cuttings 4, 6 before inserting the unrooted plant cuttings 4, 6 in the single growth cell 10. The rooting hormone can be applied by dipping a selected one or more of the unrooted plant cuttings 4, 6 into the rooting hormone before inserting one or more of the unrooted plant cuttings 4, 6 into the growth cell 10. This allows for a selected one or more of the unrooted plant cuttings 4, 6 that may be known as a slow rooting species to speed up its rooting time and sufficiently match the rooting time of the remaining one or more of the unrooted plant cuttings 4, 6 that have a naturally faster rooting time. By sufficiently matching rooting times and/or growth rates it is meant that the rooting times and/or growth rates are close enough so that balanced growth of the plant species results.

In another non-limiting embodiment, altering plant vigor of one or more of the rooted cuttings 14, 16 is performed. Altering plant vigor involves restricting plant growth of selected one or more of the rooted cuttings 14, 16. Restricting plant growth may be achieved by pinching new growth from a selected one or more of the rooted cuttings 14, 16. This allows for a selected one or more of the rooted cuttings 14, 16 that may be known as a vigorous growing species to slow down its growth rate and sufficiently match the growth rate of the remaining one or more of the rooted cuttings 14, 16 that have a naturally slower growth rate. Additionally, pinching rooted cuttings 14, 16 may be performed in order to induce primary, secondary, or additional branch growth. In a further embodiment, altering plant vigor involves at least one of adjusting the pH of the growth cell 10, regulating light exposure to the growth cell 10, regulating the temperature of the growth cell 10, and applying a growth modifier to one or more of the rooted cuttings 14, 16. As discussed above, suitable growth modifiers include, but are not limited to the following: plant hormones, such as, abscisic acid, auxins, cytokinins, ethylene, gibberellins, brassinolides, salicylic acid, jasmonates, signaling peptides, systemin, polyamines, nitric oxide, and strigolactones.

As shown in FIG. 2, the rooted cuttings 14, 16 grow and establish a plurality of roots in the growing medium 12 of the growth cell 10. Once the rooted cuttings are sufficiently established, the rooted cuttings are transferred to a growing container 20, as shown in FIG. 3, having a growing medium consisting at least in part of potting soil, perlite, vermiculite, sphagnum, peat moss, clay, white pied, and any combinations thereof, along with any necessary water and optional nutrients to ensure optimum growth of the rooted cutting. As further shown in FIG. 3, two rooted cuttings are transferred to container 20. However, this is for example purposes only, i.e., one or more rooted cuttings of the same or different plant species can be transferred to container 20 having a growing medium as discussed above. A further embodiment includes rooting the unrooted cutting 4, 6 of FIG. 1 directly in growing container 20 of FIG. 3 to sufficiently establish roots. Still further as shown in FIG. 3, growing shoots 24, 26 are grown from rooted cutting 14, 16 of FIG. 2. The growing shoots 24, 26 are further grown in container 20 to a length such that when the shoots are bent, the terminal ends of the shoots make contact with any supporting means within container 20, outside container 20, or to a surface of container 20. A supporting means includes, for example, but is not limited to the edge of the container, on the frame of a container with no solid sides, on an object such as a globe or cube placed on top of the surface of the container's growing medium, or to a hanging means attached to the container. In another embodiment, the shoots 24, 26 are grown such that each shoot has at least one or more nodes that is capable of producing at least one primary branch.

As shown in FIG. 4, the now growing shoots 34, 36 having at least one node and having the capability of producing at least one primary branch are bent in a direction different from the growing shoots' original growing axis. Normally, the shoot is bent in a direction opposite its starting position of growth in container 20. However, this is fbr example purposes only, i.e., the shoots 34, 36 can be bent in any direction. As further shown in FIG. 4, the terminal ends of 34, 36 are fastened with an orchid flower spike fastening clip 60, 70. However, this is for example purpose only, i.e., other fastening means can be used. For the purposes of example in FIG. 4, the terminal ends of 34, 36 are fastened to the edge or rim of container 20. Other embodiments include fastening the terminal ends of 34, 36 to any supporting means within container 20, outside container 20, or to a surface of container 20. A supporting means can include but is not limited to the frame of a container with no solid sides, on an object such as a globe or cube placed on top of the surface of the container's growing medium, or to a hanging means attached to the container.

In one non-limiting embodiment, the terminal ends of growing shoots 34 or 36 or both 34 and 36 are pinched. Once pinched, apical dominance is removed thus allowing primary branches to develop from nodes on growing shoots 34, 36. However, pinching is an optional step depending on the plant species, i.e, some species develop primary branches without removing apical dominance, whereas other species require removing apical dominance for more vigorous growth of primary branches. Other means of removing apical dominance include, but are not limited to, killing by chemical means, pruning or cutting off the end of growing shoots 34, 36. Removing apical dominance can take place before or after the shoot is bent or before or after the shoot is fastened to a supporting means.

As shown in FIG. 5, in one embodiment, primary branches 44, 46 are grown from fastened shoots 34, 36. The primary branches may be grown to a length such that, when the primary branches are bent, the terminal ends of the primary branches make contact with any supporting means within container 20, outside container 20, or to a surface of container 20. A supporting means can include but is not limited to the frame of a container with no solid sides, on an object such as a globe or cube placed on top of the surface of the container's growing medium, or to a hanging means attached to the container. In another embodiment, the primary branches 44, 46 are grown such that each primary branch has at least one or more nodes that will produce at least one secondary branch.

As shown in FIG. 6, the growing primary branches 54, 56 having at least one node and having the capability of producing at least one secondary branch are bent in a direction different from the growing primary branch's original growing axis. In one embodiment, the primary branch is bent in a direction opposite its starting position of growth on shoots 34, 36 of FIG. 5. However, this is for example purposes only, i.e., the primary branches 54, 56 can be bent in any direction. As further shown in FIG. 6, the terminal ends of 54, 56 are fastened with an orchid flower spike fastening clip 80, 90. However, this is for example purpose only, i.e., other fastening means can be used. For purposes of example in FIG. 6, the terminal ends of 54, 56 are fastened to the edge or rim of container 20. Other embodiments include fastening the terminal ends of 54, 56 to any supporting means within container 20, outside container 20, or to a surface of container 20. A supporting means can include but is not limited to the frame of a container with no solid sides, on a object such as a globe or cube placed on top of the surface of the container's growing medium, or to a hanging means attached to the container.

In one non-limiting embodiment, the terminal ends of primary branches 54 or 56 or both 54 and 56 are pinched. Once pinched, apical dominance is removed thus allowing secondary branches to develop from nodes on primary branches 54, 56. However, pinching is an optional step depending on the plant species, i.e, some species develop secondary branches without removing apical dominance, whereas other species require removing apical dominance for more vigorous growth of secondary branches. Other means of removing apical dominance include, but are not limited to, killing by chemical means, pruning or cutting off the end of primary branches 54, 56. Removing apical dominance can take place before or after the primary branch is bent or before or after the primary branch is fastened to a supporting means.

As shown in FIG. 7, a horticultural display is produced from the various embodiments as shown in FIGS. 1-6 and versions thereof. Unexpectedly, the method of the present invention and the various embodiments create a very full and attractive horticultural display. This is very surprising especially when using plant genera and species that are avoided by plant producers because of the difficulty of growing these plants compactly and uniformly. Although not limiting, these plants include woody stem vines and climbers. In accordance with this embodiment, using the method of the present invention, an unexpectedly greater number of plant genera and species can now be grown and offered for sale as attractive container plants. Embodiments as shown in FIGS. 1-7 are for example purposes only. Other embodiments include growing secondary branches from primary branches, bending secondary branches, and fastening secondary branches to any supporting means within container 20, outside container 20, or to a surface of container 20. A supporting means can include but is not limited to the frame of a container with no solid sides, on an object such as a globe or cube placed on top of the surface of the container's growing medium, or to a hanging means attached to the container. Furthermore, the apical meristems of secondary branches can be removed to induce the growth of tertiary branches. An even further embodiment is growing additional branches from secondary branches, bending tertiary branches, and fastening tertiary branches to any supporting means within container 20, outside container 20, or to a surface of container 20. A supporting means can include but is not limited to the frame of a container with no solid sides, on an object such as a globe or cube placed on top of the surface of the container's growing medium, or to a hanging means attached to the container.

For purposes of this description, it is to be understood that embodiments of the invention may assume various alternative variations and step sequences. It is also to be understood that plant genera and species, as well as growing containers and fasteners described in the specification are simply exemplary embodiments.

### EXAMPLES

The following examples of types of plant species and genera and various growing containers for which the BFP system of the present invention can be used are not meant to be limiting. In addition, the fastening position and the embodiments thereof are not meant to be limiting. These examples demonstrate various embodiments of the BFP system. The BFP system can be used to grow vines, climbers and other plant types and species that were previously very difficult and/or not possible to grow into compact and uniform container plants. Many of these difficult to grow plants are botanically classified in the following plant families: Caprifoliaceae (Honey suckle), Apocynaceae (Mandevilla), Vitaceae (Cissus), Convolvulaceae (Morning glory), Ranunculaceae (Clematis), Araliaceae (Ivy), Oleaceae (Jasmines), Nyctaginaceae (Bougainvillea), Fabaceae (Wisteria), Bignoniaceae (Campis), Acanthaceae (Thunbergia), and Passifloraceae (Passiflora).

Many types of growing containers are available from commercial nursery supply companies. Containers vary in composition, size, and shape. The most widely used are solid plastic growing containers. Containers composed of wire, peat, or fiber or other material are well known in the art of container plant production. Furthermore, any of these various container embodiments can have a hanging device attached to the container. The hanging device provides a means for suspending the container from a support. This hanging device can also provide a support means to fasten the shoots and branches of the present invention.

### Example 1

### Mandevilla Branches Fastened to the Container's Edge

Two or more plants of Mandevilla were planted into the growing medium of a container. The plant's shoot was grown to a length so that when the shoot was bent, the end of the shoot reached the edge of the container, and the shoot had at least one or more lateral meristems. With the shoot in the bent position, the shoot was fastened to the edge of the container with an orchid flower spike fastening clip. However, this is for example purpose only, i.e., other fastening means can be used. Care was taken not to break the branch. During the bending phase, the apical meristem was removed by pinching the terminal end of the growing shoot. Removing the apical meristem stimulated the lateral meristems to produce primary branches. The primary branches were grown to a length so that when the primary branches were bent, the ends of the primary branches reached the edge of the container, and the primary branches had at least one or more additional lateral meristems. With the primary branches in the bent position, the primary branches were fastened to the edge of the container with an orchid flower spike fastening clip. However, this is for example purpose only, i.e., other fastening means can be used. The apical meristems were removed by pinching the terminal ends of the growing primary branches. Removing the apical meristem of the primary branches stimulated lateral meristems to produce secondary branches. Repeating the steps of growing branches, bending branches, fastening branches and removing the apical meristem resulted in the plants having a compact and uniform growth and increased the quantity of flowers.

### Example 2

### Mandevilla Branches Fastened to the Surface of the Growing Medium

Two or more plants of Mandevilla are planted into the growing medium of a growing container. The plant's shoot is grown to a length so that when the shoot is bent, the end of the shoot makes contact with the surface of the growing medium in the container, and the shoot has at least one or more lateral meristems. With the shoot in the bent position, the shoot is fastened to the surface of the growing medium with a fastening means. The apical meristem is removed by pinching the terminal end of the growing branch. Removing the apical meristem stimulates the lateral meristems to produce primary branches. The plant's primary branches are grown to a length so that when the primary branches are bent, the ends of the primary branches make contact with the surface of the growing medium in the container, and the primary branches have at least one or more lateral meristems. With the primary branches in the bent position, the primary branches are fastened to the surface of the growing medium with a fastening means. The apical meristem is removed by pinching the terminal ends of the growing primary branches. Removing the apical meristem of the primary branches stimulates additional lateral meristems to produce secondary branches. Repeating the steps of growing branches, bending branches, fastening branches and removing the apical meristem results in the plants having a compact and uniform growth and increases the quantity of flowers.

### Example 3

### Mandevilla Branches Fastened to a Hanging Means Attached to a Hanging Container

Two or more plants of Mandevilla are planted into the growing medium of a growing container. The Mandevilla plants are grown in a container having a hanging means secured to the container and an attachment means at the distal end of the hanging means to suspend the container from a support. The plant's shoot is grown to a length so that when the shoot is bent, the end of the shoot makes contact with the hanging means of the container, and the shoot has at least one or more lateral meristems. With the shoot in the bent position, the shoot is fastened with a fastening means to the container's hanging means. The apical meristem is removed by pinching the terminal end of the growing shoot. Removing the apical meristem stimulates the lateral meristems to produce primary branches. The plant's primary branches are grown to a length so that when the primary branches are bent, the ends of the primary branches make contact with the hanging means of the container, and the primary branches have at least one or more lateral meristems. With the primary branches in the bent position, the primary branches are fastened with a fastening means to the container's hanging means. The apical meristem is removed by pinching the terminal ends of the growing primary branches. Removing the apical meristem of the primary branches stimulates additional lateral meristems to produce secondary branches. Repeating the steps of growing branches, bending branches, fastening branches and removing the apical meristem results in the plants having a compact and uniform growth and increases the quantity of flowers.

### Example 4

### Mandevilla Branches Fastened to the Outside Surface of the Growing Container

Two or more plants of Mandevilla are planted into the growing medium of a growing container. The plant's shoot is grown to a length so that when the shoot is bent, the end of the shoot makes contact with the outer surface of the growing container, and the shoot has at least one or more lateral meristems. With the shoot in the bent position, the shoot is fastened with a fastening means to the outer surface of the growing container. The apical meristem is removed by pinching the terminal end of the growing shoot. Removing the apical meristem stimulates the lateral meristems to produce primary branches. The plant's primary branches are grown to a length so that when the primary branches are bent, the ends of the primary branches make contact with the outer surface of the growing container, and the primary branches have at least one or more additional lateral meristems. With the primary branches in the bent position, the primary branches are fastened with a fastening means to the outer surface of the growing container. The apical meristem is removed by pinching the terminal ends of the growing primary branches. Removing the apical meristem of the primary branches stimulates lateral meristems to produce secondary branches. Repeating the steps of growing branches, bending branches, fastening branches and removing the apical meristem results in the plants having a compact and uniform growth and increases the quantity of flowers.

### Example 5

### Mandevilla Branches Fastened to a Supporting Means Placed on Top of the Surface of the Growing Medium

Two or more plants of Mandevilla are placed into the growing medium of a growing container. The Mandevilla plants are grown in a container having supporting means placed on top of the surface of the growing medium. The plant's shoot is grown to a length so that when the shoot is bent, the end of the shoot makes contact with the supporting means, and the shoot has at least one or more lateral meristems. The plant's shoot is fastened with a fastening means to the supporting means. The apical meristem is removed by pinching the terminal end of the growing shoot. Removing the apical meristem stimulates the lateral meristems to produce primary branches. The plant's primary branches are grown to a length so that when the primary branches are bent, the ends of the primary branches make contact with the supporting means, and the primary branches have at least one or more lateral meristems. The plant's primary branches are fastened with a fastening means to the supporting means. The apical meristem is removed by pinching the terminal ends of the growing primary branches. Removing the apical meristems of the primary branches stimulates lateral meristems to produce secondary branches. Repeating the steps of growing branches, bending branches, fastening branches and removing the apical meristem results in the plants having a compact and uniform growth and increases the quantity of flowers.

Although not limiting, the following embodiments of the present invention vary with plant variety, container type, and position of the fastened branch.

### Example 6

### Using the BFP System to Grow Mandevilla

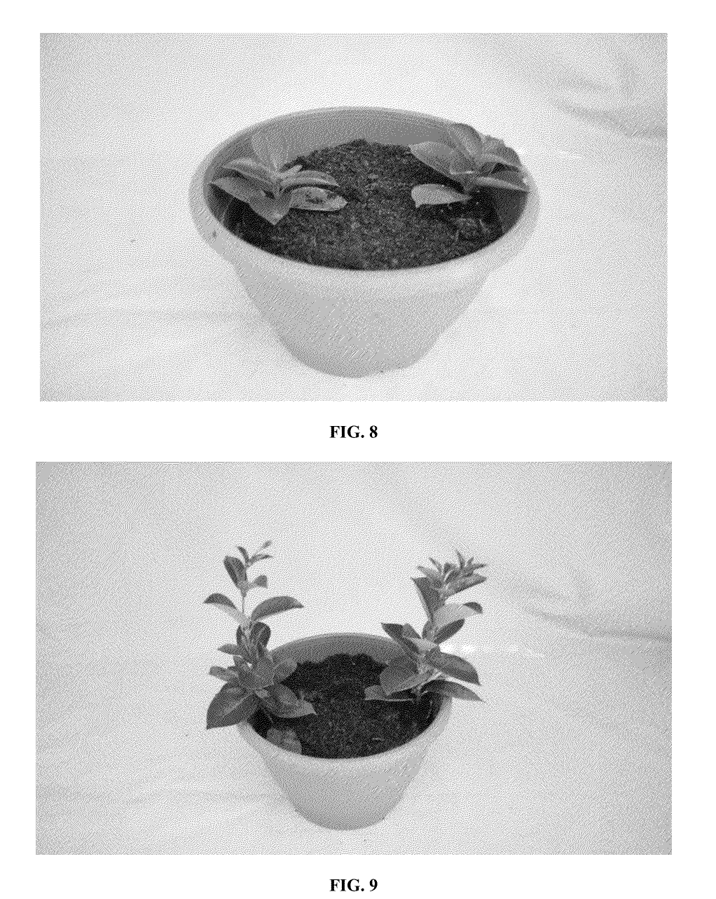

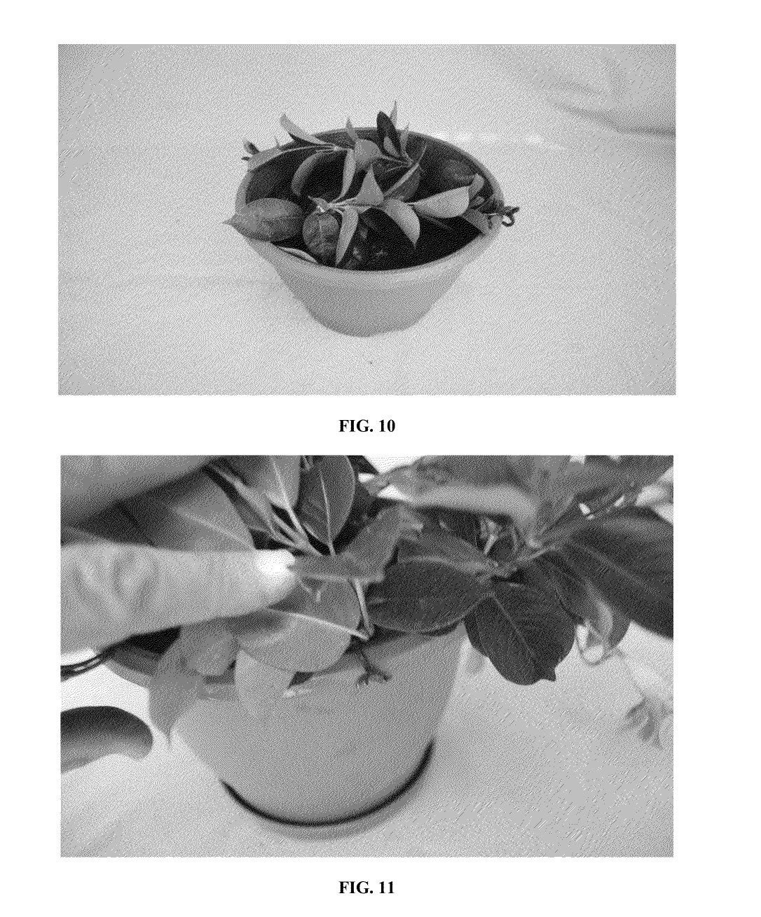

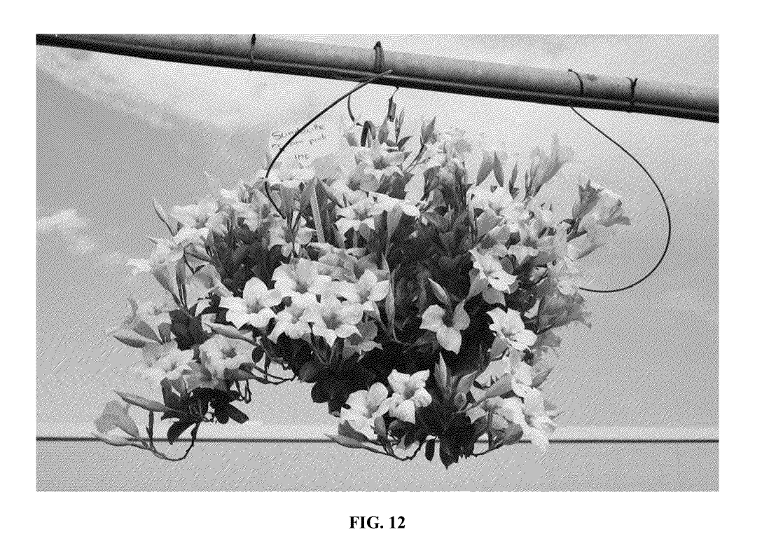

As shown in FIG. 8, two or more plants of Mandevilla are planted into the growing medium of a growing container. In one embodiment, the growing container has solid sides. In another embodiment, the container is a frame with no solid sides. In another embodiment the growing container has an object such as a globe or cube placed on top of the surface of the container's growing medium. In a further embodiment the growing container has a hanging means attached to the container and having at its distal end a device to suspend the container from a support. As shown on FIG. 9, the Mandevilla plants are grown to a length so that when the plants' shoots are bent, the ends of the shoots make contact with a support means on or attached to the container. As shown in FIGS. 10 and 11, a fastening means is used to fasten the terminal end of the shoots to a position on the edge of the growing container. Alternatively, the shoots can be fastened on the frame of a container with no solid sides, on an object such as a globe or cube placed on top of the surface of the container's growing medium, or to a hanging means attached to the container. The apical meristem is removed by pinching the terminal end of the growing shoots. By removing the apical meristem, primary branching occurs from lateral meristems along the sides of the shoots. These primary branches are allowed to grow so that when the primary branches are bent, the ends of the primary branches make contact with a support means on or attached to the container. A fastening means is used to fasten the terminal ends of the primary branches to a position on edge of the growing container, on a frame of a container with no solid sides, on a object such as a globe or cube placed on top of the surface of the container's growing medium, or to a hanging means attached to the container. The apical meristem is removed by pinching the terminal ends of the growing primary branches. This stimulates lateral meristems on the primary branches to produce secondary branches. As shown in FIG. 12, growing branches, fastening branches to a support means, and removing the apical meristem by pinching the terminal ends of the branches can occur as many times until a compact, uniform, and floriferous container plant is achieved.

The following examples in Tables 1-3 show results of a trial that was conducted in 2012 with three Mandevilla varieties. The trial consisted of 27 pots of each variety grown using the BFP method and 27 pots of each variety grown without using the BFP method. The pot size was 20 cm and two rooted plugs were planted into each pot at week 6 of 2012. For plants grown using the BFP method, BFP was applied at week 11 and week 18 of 2012. For plants grown without using the BFP method, the apical meristems were pinched at week 11 of and week 18 of 2012. Data was collected at week 27 of 2012. For each characteristic, the data recorded is an average of the 27 pots for each of the three varieties grown with and without BFP.

TABLE 1

| | With BFP method | Without BFP method |
|---|---|---|
| | Mandevilla | Mandevilla |
| Characteristic | ‘Velvet Red’ | ‘Velvet Red’ |
| Plant height (cm) | 17 | 20 |
| Plant fresh weight without | 100 | 50 |
| roots (grams) | | |
| Quantity of branches | 14 | 8 |
| Branch length (cm) | 10 | 15 |
| Internode length (cm) | 2.5 | 3.0 |
| Quantity of flowers | 2 | 0 |

As shown in Table 1, Mandevilla ‘Velvet Red’ grown with the BFP method had an average plant height of 17 cm, an average fresh weight of 100 grams, an average quantity of branches of 14, an average branch length of 10 cm, an average internode length of 2.5 cm and averaged 2 flowers per plant, whereas ‘Velvet Red’ grown without the BFP method had an average plant height of 20 cm, an average fresh weight of 50 grams, an average quantity of branches of 8, an average branch length of 15 cm, an average internode length of 3.0 cm and averaged 0 flowers per plant. In terms of percentages, the average plant height of ‘Velvet Red’ when grown with the BFP method was surprisingly 15% less than the plant height of ‘Velvet Red’ grown without the BFP method. Also, the average fresh weight of ‘Velvet Red’ grown with the BFP method unexpectedly increased by 100% over ‘Velvet Red’ grown without the BFP method. Additionally, the average quantity of branches of ‘Velvet Red’ unexpectedly increased by 75% over ‘Velvet Red’ grown without the BFP method. An additional unexpected result was that the average branch length of ‘Velvet Red’ grown with the BFP method was 33% less than the average branch length of ‘Velvet Red’ grown without the BFP method. Still further, another unexpected result was that the average internode length of ‘Velvet Red’ grown with the BFP method was 17% less than the internode length of ‘Velvet Red’ grown without the BFP method.

TABLE 2

| | With BFP method | Without BFP method |
|---|---|---|
| | Mandevilla | Mandevilla |
| Characteristic | ‘Rose Star’ | ‘Rose Star’ |
| Plant height (cm) | 17 | 20 |
| Plant fresh weight without | 132 | 65 |
| roots (grams) | | |
| Quantity of branches | 16 | 10 |
| Branch length (cm) | 10 | 15 |
| Internode length (cm) | 2.5 | 3.0 |
| Quantity of flowers | 6 | 0.25 |

As shown in Table 2, Mandevilla ‘Rose Star’ grown with the BFP method had an average plant height of 17 cm, an average fresh weight of 132 grams, an average quantity of branches of 16, an average branch length of 10 cm, an average internode length of 2.5 cm and averaged 6 flowers per plant, whereas ‘Rose Star’ grown without the BFP method had an average plant height of 20 cm, an average fresh weight of 65 grams, an average quantity of branches of 10, an average branch length of 15 cm, an average internode length of 3.0 cm and averaged 0.25 flowers per plant. In terms of percentages, the average plant height of ‘Rose Star’ when grown with the BFP method was surprisingly 15% less than the plant height of ‘Rose Star’ grown without the BFP method. Also, the average fresh weight of ‘Rose Star’ grown with the BFP method unexpectedly increased by more than 100% over ‘Rose Star’ grown without the BFP method. Additionally, the average quantity of branches of ‘Rose Star’ unexpectedly increased by 60% over ‘Rose Star’ grown without the BFP method. An additional unexpected result was that the average branch length of ‘Rose Star’ grown with the BFP method was 33% less than the average branch length of ‘Rose Star’ grown without the BFP method. Still further, another unexpected result was the average internode length of ‘Rose Star’ grown with the BFP method was 17% less than the internode length of ‘Rose Star’ grown without the BFP method. Still even further, another unexpected result was the average number of flowers of ‘Rose Star’ grown with the BFP method was 24 times greater than the average number of flowers of ‘Rose Star’ grown without BFP.

TABLE 3

| | With BFP method | Without BFP method |
|---|---|---|
| | Mandevilla | Mandevilla |
| Characteristic | ‘Burgundy’ | ‘Burgundy’ |
| Plant height (cm) | 17 | 20 |
| Plant fresh weight without | 116 | 67 |
| roots (grams) | | |
| Quantity of branches | 16 | 8 |
| Branch length (cm) | 10 | 15 |
| Internode length (cm) | 2.5 | 3.0 |
| Quantity of flowers | 5 | 1 |

As shown in Table 3, Mandevilla ‘Burgundy’ grown with the BFP method had an average plant height of 17 cm, an average fresh weight of 116 grams, an average quantity of branches of 16, an average branch length of 10 cm, an average internode length of 2.5 cm and averaged 5 flowers per plant, whereas ‘Burgundy’ grown without the BFP method had an average plant height of 20 cm, an average fresh weight of 67 grams, an average quantity of branches of 8, an average branch length of 15 cm, an average internode length of 3.0 cm and averaged 1 flower per plant. In terms of percentages, the average plant height of ‘Burgundy’ when grown with the BFP method was surprisingly 15% less than the average plant height of ‘Burgundy’ grown without the BFP method. Also, the average fresh weight of ‘Burgundy’ grown with the BFP method unexpectedly increased by 73% over ‘Burgundy’ grown without the BFP method. Additionally, the average quantity of branches of ‘Burgundy’ unexpectedly increased by 100% over ‘Burgundy’ grown without the BFP method. An additional unexpected result was that the average branch length of ‘Burgundy’ grown with the BFP method was 33% less than the average branch length of ‘Burgundy’ grown without the BFP method. Still further, another unexpected result was that the average internode length of ‘Burgundy’ grown with the BFP method was 17% less than the average internode length of ‘Burgundy’ grown without the BFP method. Still even further, another unexpected result was that the average number of flowers of ‘Burgundy’ grown with the BFP method was 5 times greater than the average number of flowers of ‘Burgundy’ grown without BFP.

### Example 7

### Using the BFP System to Grow Clematis

Two or more plants of Clematis are planted into the growing medium of a growing container. In one embodiment, the growing container has solid sides. In another embodiment, the container is a frame with no solid sides. In another embodiment the growing container has an object such as a globe or cube placed on top of the surface of the container's growing medium. In a further embodiment the growing container has a hanging means attached to the container and having at its distal end a device to suspend the container from a support. The Clematis plants are grown to a length so that when the plants' shoots are bent, the ends of the shoots make contact with a support means on or attached to the container. A fastening means is used to fasten the terminal end of the shoots to a position on edge of the growing container, on the frame of a container with no solid sides, on an object such as a globe or cube placed on top of the surface of the container's growing medium, or to a hanging means attached to the container. The apical meristem is removed by pinching the terminal end of the growing shoots. By removing the apical meristem, primary branching occurs from lateral meristems along the sides of the shoots. These primary branches are allowed to grow so that when the primary branches are bent, the ends of the primary branches make contact with a support means on or attached to the container. A fastening means is used to fasten the terminal ends of the primary branches to a position on edge of the growing container, on the frame of a container with no solid sides, on an object such as a globe or cube placed on top of the surface of the container's growing medium, or to a hanging means attached to the container. The apical meristem is removed by pinching the terminal ends of the growing primary branches. This stimulates lateral meristems on the primary branches to produce secondary branches. Growing branches, fastening branches to a support means, and removing the apical meristem by pinching the terminal ends of the branches can occur as many times until a compact, uniform, and floriferous container plant is achieved.

### Example 8

### Using the BFP System to Grow Bougainvillea

Two or more plants of Bougainvillea are planted into the growing medium of a growing container. In one embodiment, the growing container has solid sides. In another embodiment, the container is a frame with no solid sides. In another embodiment the growing container has an object such as a globe or cube placed on top of the surface of the container's growing medium. In a further embodiment the growing container has a hanging means attached to the container and having at its distal end a device to suspend the container from a support. The Bougainvillea plants are grown to a length so that when the plants' shoots are bent, the ends of the shoots make contact with a support means on or attached to the container. A fastening means is used to fasten the terminal end of the shoots to a position on edge of the growing container, on the frame of a container with no solid sides, on an object such as a globe or cube placed on top of the surface of the container's growing medium, or to a hanging means attached to the container. The apical meristem is removed by pinching the terminal end of the growing shoots. By removing the apical meristem, primary branching occurs from lateral meristems along the sides of the shoots. These primary branches are allowed to grow so that when the primary branches are bent, the ends of the primary branches make contact with a support means on or attached to the container. A fastening means is used to fasten the terminal ends of the primary branches to a position on edge of the growing container, on the frame of a container with no solid sides, on an object such as a globe or cube placed on top of the surface of the container's growing medium, or to a hanging means attached to the container. The apical meristem is removed by pinching the terminal ends of the growing primary branches. This stimulates lateral meristems on the primary branches to produce secondary branches. Growing branches, fastening branches to a support means, and removing the apical meristem by pinching the terminal ends of the branches can occur as many times until a compact, uniform, and floriferous container plant is achieved.

### Example 9

### Using the BFP System to Grow Wisteria

Two or more plants of Wisteria are planted into the growing medium of a growing container. In one embodiment, the growing container has solid sides. In another embodiment, the container is a frame with no solid sides. In another embodiment the growing container has an object such as a globe or cube placed on top of the surface of the container's growing medium. In a further embodiment the growing container has a hanging means attached to the container and having at its distal end a device to suspend the container from a support. The Wisteria plants are grown to a length so that when the plants' shoots are bent, the ends of the shoots make contact with a support means on or attached to the container. A fastening means is used to fasten the terminal end of the shoots to a position on edge of the growing container, on the frame of a container with no solid sides, on an object such as a globe or cube placed on top of the surface of the container's growing medium, or to a hanging means attached to the container. The apical meristem is removed by pinching the terminal end of the growing shoots. By removing the apical meristem, primary branching occurs from lateral meristems along the sides of the shoots. These primary branches are allowed to grow so that when the primary branches are bent, the ends of the primary branches make contact with a support means on or attached to the container. A fastening means is used to fasten the terminal ends of the primary branches to a position on edge of the growing container, on the frame of a container with no solid sides, on an object such as a globe or cube placed on top of the surface of the container's growing medium, or to a hanging means attached to the container. The apical meristem is removed by pinching the terminal ends of the growing primary branches. This stimulates lateral meristems on the primary branches to produce secondary branches. Growing branches, fastening branches to a support means, and removing the apical meristem by pinching the terminal ends of the branches can occur as many times until a compact, uniform, and floriferous container plant is achieved.

### Example 10

### Using the BFP System to Grow Geranium

Two or more plants of Geranium are planted into the growing medium of a growing container. In one embodiment, the growing container has solid sides. In another embodiment, the container is a frame with no solid sides. In another embodiment the growing container has an object such as a globe or cube placed on top of the surface of the container's growing medium. In a further embodiment the growing container has a hanging means attached to the container and having at its distal end a device to suspend the container from a support. The Geranium plants are grown to a length so that when the plants' shoots are bent, the ends of the shoots make contact with a support means on or attached to the container. A fastening means is used to fasten the terminal end of the shoots to a position on edge of the growing container, on the frame of a container with no solid sides, on an object such as a globe or cube placed on top of the surface of the container's growing medium, or to a hanging means attached to the container. The apical meristem is removed by pinching the terminal end of the growing shoots. By removing the apical meristem, primary branching occurs from lateral meristems along the sides of the shoots. These primary branches are allowed to grow so that when the primary branches are bent, the ends of the primary branches make contact with a support means on or attached to the container. A fastening means is used to fasten the terminal ends of the primary branches to a position on edge of the growing container, on the frame of a container with no solid sides, on an object such as a globe or cube placed on top of the surface of the container's growing medium, or to a hanging means attached to the container. The apical meristem is removed by pinching the terminal ends of the growing primary branches. This stimulates lateral meristems on the primary branches to produce secondary branches. Growing branches, fastening branches to a support means, and removing the apical meristem by pinching the terminal ends of the branches can occur as many times until a compact, uniform, and floriferous container plant is achieved.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1. A method of producing a horticultural display comprising:
a. planting one or more plants in a growing medium;
b. growing each plant to produce a shoot;
c. bending said shoot and fastening said shoot to a support to maintain said shoot in a bent position; and
d. growing one or more primary branches from said shoot.

2. The method of claim 1, further comprising removing an apical meristem from said shoot.

3. The method of claim 1, further comprising bending one or more of said primary branches and fastening one or more said primary branches to the support to maintain said primary branches in a bent position in a manner promoting compact and uniform growth, wherein said support is selected from the group consisting of an edge of a growing container, a frame of a container having no solid sides, a hanging means, and a frame of an object placed on the surface of a container's growing medium.

4. The method of claim 1, wherein said plant is selected from the group consisting of Caprifoliaceae, Apocynaceae, Vitaceae, Convolvulaceae, Ranunculaceae, Araliaceae, Fabaceae, Nyctaginaceae and Oleaceae plant families.

5. The method of claim 1, wherein said plant is a Mandevilla plant.

6. The method of claim 1, wherein step a. comprises planting two or more plants of the same plant species in the growing medium.

7. The method of claim 1, wherein step a. comprises planting two or more plants of different plant species in the growing medium.

8. The method of claim 1, wherein step a. comprises planting two or more plants of different plant genera in the growing medium.

9. The method of claim 1, wherein step a. comprise planting two or more plants of different plant families in the growing medium.

10. A horticultural display produced by the method of claim 1.

11. The method of claim 3, further comprising:
a. growing one or more secondary branches from said one or more primary branches;
b. bending one or more secondary branches and fastening said one or more secondary branches to the support to maintain the secondary branches in a bent position in a manner promoting compact and uniform growth; and
c. growing one or more additional branches from said secondary branches.

12. The method of claim 11, further comprising removing an apical meristem from one or more of said primary branches.

13. The method of claim 11, further comprising bending said one or more additional branches and fastening said one or more additional branches to a support to maintain said additional branches in a bent position in a manner promoting compact and uniform growth, wherein said support is selected from the group consisting of an edge of a growing container, a frame of a container having no solid sides, a hanging means, and a frame of an object placed on the surface of a container's growing medium.

14. The method of claim 11, further comprising removing an apical meristem from one or more of said secondary branches.

15. A horticultural display produced by the method of claim 11.

16. A horticultural display comprising:
a growing container;
a growing medium in the growing container;
a support operatively associated with the growing container;
a fastening means; and
at least one plant growing in said growing medium with at least one of the plant shoots or branches attached to said support by the fastening means in a manner promoting compact and uniform growth.

17. The horticultural display of claim 16, wherein said support is selected from a group consisting of an edge of a growing container, a frame of a container having no solid sides, a hanging means, and a frame of an object placed on the surface of the container's growing medium.

18. A kit for growing a horticultural display, the kit comprising:
a growing container;
a growing medium;
a support configured for operative association with the growing container; and
a fastening means for associating at least one of a plant shoot and branch with the support, the fastening means being configured for operative association with the support.
